(19) United States
(12) Patent Application Publication
(10) Pub. No.: US 2013/0304431 A1
(43) Pub. Date: Nov. 14, 2013

(54) AUTOMATICALLY ASESSING MATURITY OF CUSTOM APPLICATION FOR STANDARD-GOVERNED COMPUTING ENVIRONMENT

(71) Applicants: Sateesh S. Kannegala, Bangalore (IN); Nanjangud C. Narendra, Bangalore (IN); Gandhi Sivakumar, Bentleigh (AU)

(72) Inventors: Sateesh S. Kannegala, Bangalore (IN); Nanjangud C. Narendra, Bangalore (IN); Gandhi Sivakumar, Bentleigh (AU)

(73) Assignee: INTERNATIONAL BUSINESS MACHINES CORPORATION, Armonk, NY (US)

(21) Appl. No.: 13/468,131

(22) Filed: May 10, 2012

(51) Int. Cl. G06F 7/60

(52) U.S. Cl. 703/2

(57) ABSTRACT

A system and associated method for automatically assessing maturity for a custom application in a cloud computing environment in accordance with a standard application model. A data fabric analyzer automatically calculates a logical data model compliance level to a process model for the custom application, and a maturity level the logical data model against a standard logical data model. If the logical data model is mature, the data fabric analyzer transforms the logical data model to a physical data model for implementation by a distillation process and a shearing process. If the logical data model is immature, the process model maturity is assessed to employ a standard physical model for implementing the custom application. The data fabric analyzer subsequently computes non-compliance levels for the physical model and calculates a capital expenditure cost caused by non-compliance of the custom physical model to a standard physical model.

### BACKGROUND

Conventional cloud application development is difficult because logical data models defined by cloud providers do not comply with an industry standard logical data model, and because the difference between the logical data model of the cloud providers and the industry standard logical data model is not properly assessed.

### SUMMARY

According to one embodiment of the present invention, a method for automatically assessing standard-orientation maturity for a custom application providing a service in a cloud computing environment comprises: calculating a first compliance level representing how compliant a logical data model of the custom application is to a process model of the custom application, wherein the logical data model specifies data objects of the custom application necessary to provide the service specified by the process model; calculating a first maturity level representing how well the logical data model is aligned with a standard logical data model of a standard application model, by comparing each element of the logical data model with a respectively corresponding element of the standard logical data model, wherein the standard logical data model specifies standardized data objects necessary to provide the service described in a standard process model of the standard application model in the cloud computing environment, and wherein the standard process model corresponds to the process model for the custom application; calculating a capital expenditure cost for mediating the service provided by the custom application into the standard application model based on a physical model of the custom application, a standard physical model of the standard application model, and a cost estimation template; and communicating the calculated capital expenditure cost to a user such that the user determines if the custom application is suitable for the cloud computing environment.

According to one embodiment of the present invention, a computer program product comprises a computer readable memory unit that embodies a computer readable program code. The computer readable program code contains instructions that, when run by a processor of a computer system, implement a method for automatically assessing standard-orientation maturity for a custom application providing a service in a cloud computing environment.

According to one embodiment of the present invention, a computer system comprises a processor, a memory coupled to the processor, and a computer readable storage device coupled to the processor, said storage device containing program code configured to be executed by the processor via the memory to implement a method for automatically assessing standard-orientation maturity for a custom application providing a service in a cloud computing environment.

According to one embodiment of the present invention, a process for supporting computer infrastructure, said process comprising providing at least one support service for at least one of creating, integrating, hosting, maintaining, and deploying computer-readable code in a computing system, wherein the code in combination with the computing system is capable of performing a method for automatically assessing standard-orientation maturity for a custom application providing a service in a cloud computing environment.

### BRIEF DESCRIPTION OF THE SEVERAL VIEWS OF THE DRAWINGS

FIG. 1 illustrates a system 10 for automatic maturity assessment for a cloud provider application, in accordance with embodiments of the present invention.

FIG. 2 depicts abstraction model layers of the cloud of FIG. 1, in accordance with the embodiments of the present invention.

FIG. 3 is a flowchart depicting a method for automatically assessing maturity for a cloud provider application that is performed by an intelligent data fabric analyzer (IDFA), in accordance with the embodiments of the present invention.

FIG. 4A is a flowchart depicting steps calculating compliance of a process model (PM) to a logical data model (LM) of the cloud provider application, performed as step 100 of the IDFA in FIG. 3, in accordance with the embodiments of the present invention.

FIG. 4B is a flowchart depicting steps calculating a maturity level of the LM of the cloud provider application against the standard CIM, performed as step 200 of the IDFA in FIG. 3, in accordance with the embodiments of the present invention.

FIG. 5 is a flowchart depicting steps for assessing a maturity level of the PM of the cloud provider application, performed as step 300 of the IDFA in FIG. 3, in accordance with the embodiments of the present invention.

FIG. 6 is a flowchart depicting steps for a distillation process for a physical model of the cloud provider application, performed as step 400 of the IDFA in FIG. 3, in accordance with the embodiments of the present invention.

FIG. 7 is a flowchart depicting steps for a shearing process for the physical model of the cloud provider application, performed as step 500 of the IDFA in FIG. 3, in accordance with the embodiments of the present invention.

FIG. 8 is a flowchart depicting steps for reporting analysis results produced by the IDFA, performed as step 600 of the IDFA in FIG. 3, in accordance with the embodiments of the present invention.

FIG. 9 is an exemplary analysis result E10 of Information Framework (IFW) standard E15 and a cloud provider application CPApp1 E19, as created by the IDFA, in accordance with embodiments of the present invention.

FIG. 10 is an example of a service object boundary input in step 370 of FIG. 5, in accordance with embodiments of the present invention.

FIG. 11 is an example of an estimation template input in step 640 of FIG. 8, in accordance with embodiments of the present invention.

FIG. 12 illustrates a computer system used for automatic maturity assessment for a cloud provider application, in accordance with the embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

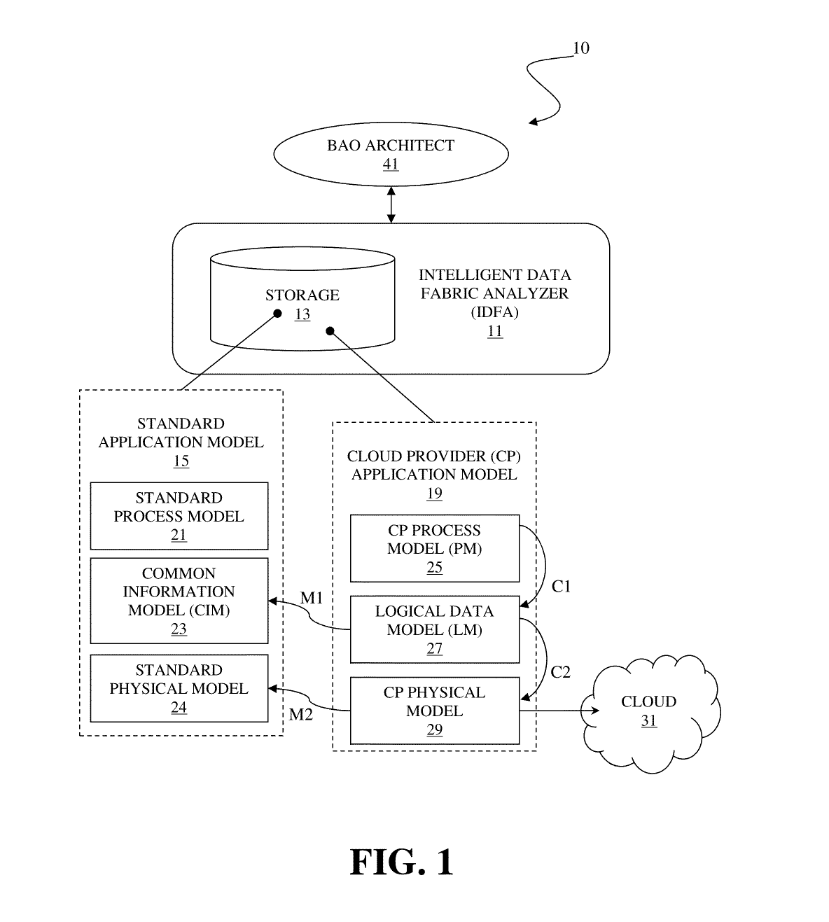

FIG. 1 illustrates a system 10 for automatic maturity assessment for a cloud provider application, in accordance with embodiments of the present invention.

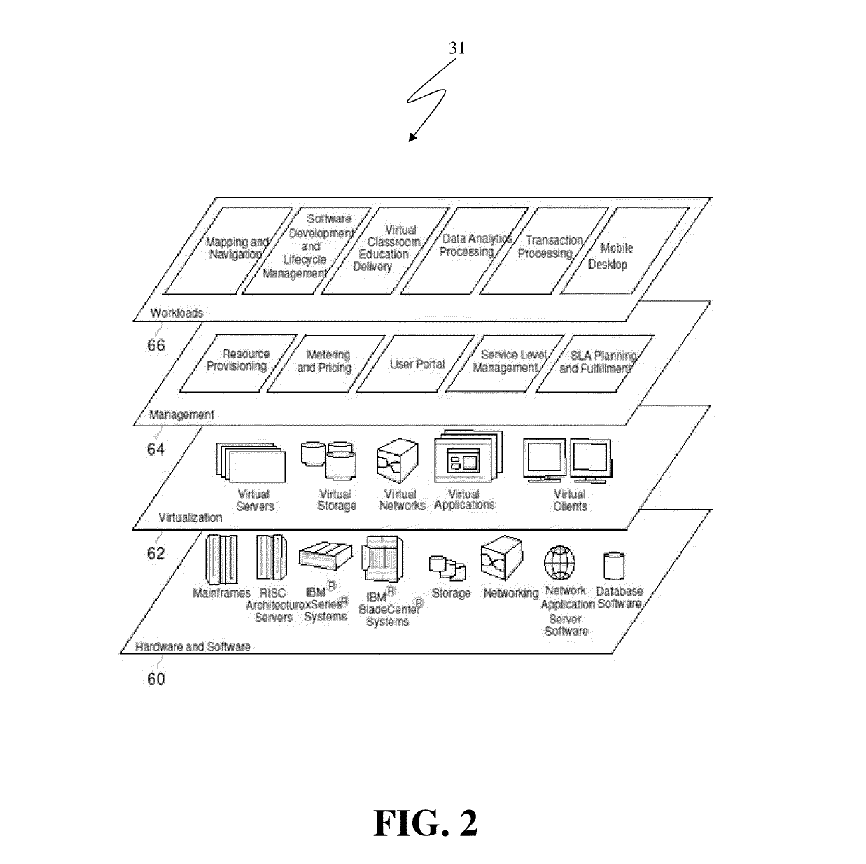

The system 10 comprises an Intelligent Data Fabric Analyzer (IDFA) 11 and a cloud 31. The cloud 31 is provided by a cloud provider to customers for a fee for services performed by cloud provider applications and/or by the cloud 31 pursuant to various service models the cloud 31 employs. See description of FIG. 2 infra for details of functional abstraction layers of the cloud 31.

Storage 13 of the IDFA 11 comprises a standard application model 15 and a cloud provider (CP) application model 19. In one embodiment of the present invention, the standard application model 15 and the CP application model 19 are represented in the Unified Modeling Language (UML) by the Object Management Group (OMG). In this specification, terms “cloud provider”, “vendor”, “enterprise”, etc., are used interchangeably to represent an entity providing a custom application according to the standard application model 15 of the industry which the entity targets for the custom application. Accordingly, term “cloud provider application model” refers to a custom application model that is compared against the standard application model 15. The cloud provider application model 19 may be another standard application model distinctive from the standard application model 15 to be assessed for compatibility.

A Business Analytics & Optimization (BAO) architect 41 provides data to the IDFA 11 to analyze maturity of a cloud provider application. The BAO architect 41 receives a report comprising results of maturity assessment and costs associated with the maturity assessment as generated by the IDFA 11. The BAO architect 41 subsequently utilizes the received reports from the IDFA 11 to optimize the CP application model 19 to improve cost effectiveness of the cloud provider application.

The standard application model 15 comprises a standard process model 21, a Common Information Model (CIM) 23, and a standard physical model 24. The standard process model 21 defines a standard workflow for a specific industry corresponding to the area of technology encompassing the cloud provider application. The CIM 23 defines data elements of a specific computing environment, for the standard process model 21, as a common set of objects and relationships among the objects such that the data elements are consistently managed within the specific computing environment. The standard physical model 24 defines an implementation-oriented model of service components interface such as a message interface. The standard application model 15 may be defined by an industry consortium such as, inter alia, Telemanagement Forum (TMF) for telecommunication management industry, etc. An example of the CIM 23 may be, inter alia, Telemanagement Forum's Shared Information Data Model (TMF SID), etc.

The CP application model 19 comprises a CP process model (PM) 25, a logical data model (LM) 27, and a CP physical model 29, in modeling the cloud provider application within the IDFA 11. The PM 25 functionally corresponds to the standard process model 21 of the standard application model 15 in defining a workflow of the cloud provide application. The LM 27 functionally corresponds to the CIM 23 of the standard application model 15 in defining data elements of the process model 25. The CP physical model 29 defines implementation of services of the cloud provider application represented in, inter alia, Web Service Definition Language (WSDL), Extensible Markup Language (XML) Schema Definition Tool (XSD), etc., which is executable in the cloud 31.

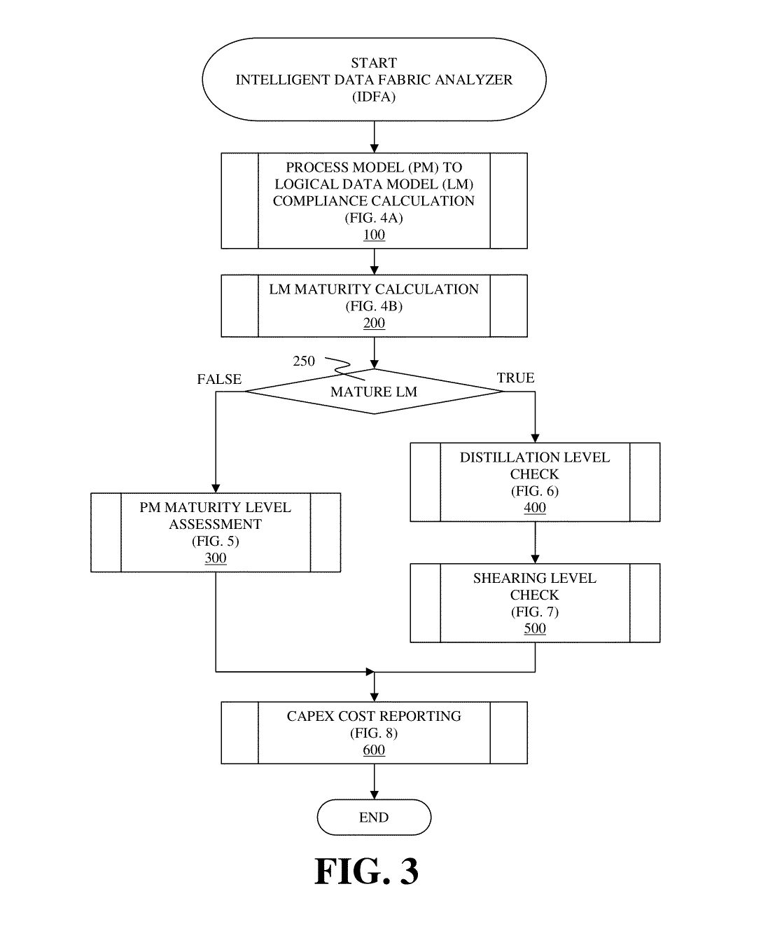

The IDFA 11 automatically analyzes maturity of the cloud provider application by comparing components of the CP application model 19 with a standard application model 15 according to one embodiment of the present invention as described in FIG. 3 infra.

In this specification, term “data maturity level” defines a degree of conformance of the LM 27 of the CP application model 19 to the CIM 23 of the standard application model 15, as shown with Arrow M1. Arrow M2 represents a physical model maturity level, as assessed during the shearing level check in step 500 of FIG. 3 infra. Also in this specification, terms “data compliance” and “data alignment” are used interchangeably to quantify how the PM 25 is abstracted into the LM 27 within the CP application model 19, as shown with Arrow C1. The terms “data maturity” and “maturity” are interchangeably used to indicate cross-model resemblance level between the standard application model 15 and the CP application model 19, for respective process models, respective logical data models, and respective physical models. The term “compliance” is also used to represent a level of alignment between the LM 27 and the CP physical model 29 within the CP application model 19, as shown with Arrow C2.

FIG. 2 depicts a set of functional abstraction layers provided by the cloud 31 of FIG. 1 supra, according to the embodiments of the present invention.

In this specification, the cloud 31 is an instance of a cloud computing environment. It should be understood in advance that the components, layers, and functions shown in FIG. 2 are intended to be illustrative only and embodiments of the invention are not limited thereto.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may be located on-premises or off-premises.

Community cloud: the cloud infrastructure is shared by several organizations and supports a specific community that has shared concerns (e.g., mission, security requirements, policy, and compliance considerations). The cloud infrastructure may be managed by the organizations or a third party and may be located on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

As depicted, the following layers and corresponding functions are provided: Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop, etc. In this specification, the cloud provider application refers to one or more functionalities of the workloads layer 66.

FIG. 3 is a flowchart depicting a method for automatically assessing maturity for a cloud provider application performed by an intelligent data fabric analyzer (IDFA), in accordance with the embodiments of the present invention.

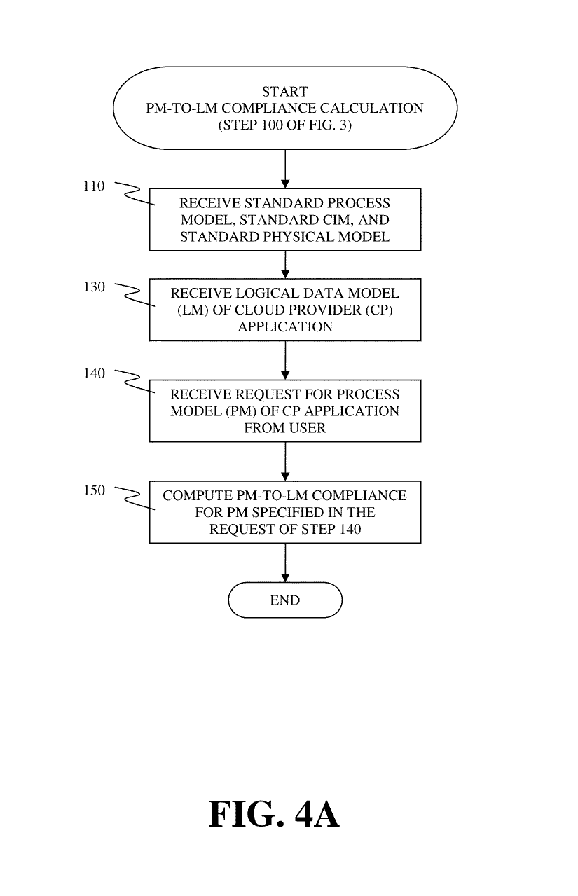

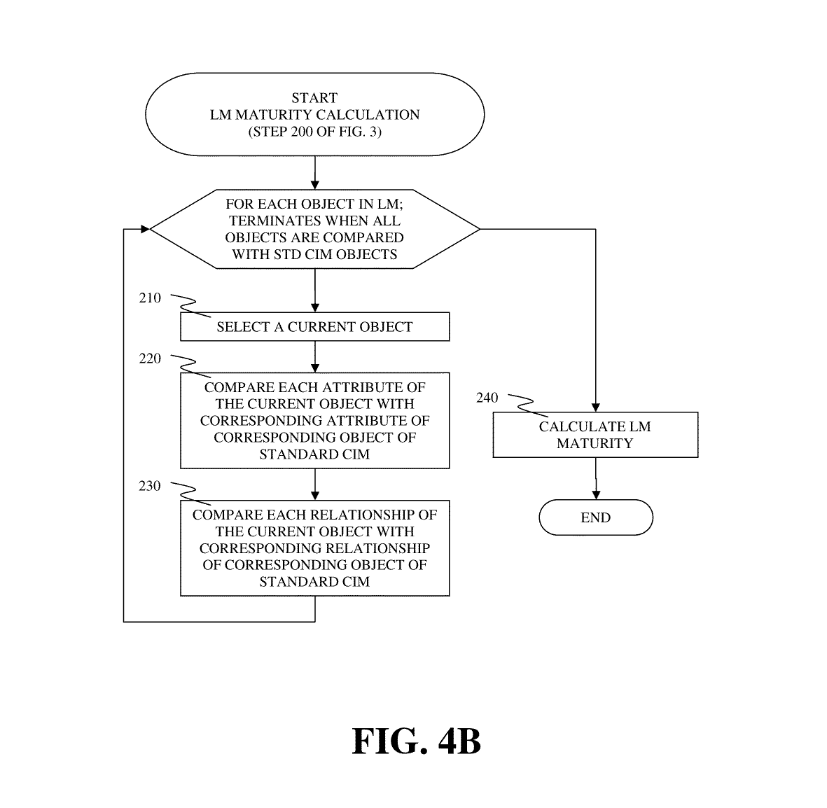

In step 100, the IDFA calculates data compliance of a cloud provider application by quantifying how a process model (PM) is transitioned into a logical data model (LM) within the cloud provider application. The cloud provider application is an instance of the cloud provider application model. The cloud provider application model is assessed against a standard application model comprising a standard process model, a common information model (CIM), and a standard physical model. See FIG. 4A infra and accompanying description for details of step 100. Then the IDFA proceeds with step 200.

In step 200, the IDFA calculates a maturity level of the LM in percentage (%) by comparing each data object of the LM with the Common Information Model (CIM) of the standard application model. See FIG. 4B infra and accompanying description for details of step 200. Then the IDFA proceeds with step 250.

In step 250, the IDFA determines if the LM of the cloud provider application is mature based on a maturity threshold and the maturity level calculated in step 200 supra. The maturity threshold may be, inter alia, 80%, indicating that wherein 80% or more of the data objects/attributes/relationships in the LM of the cloud provider application conforms to the CIM of the standard application model, then the LM is regarded as mature. An immature LM is non-conformant with the CIM of the standard application model, and may have a larger degree of semantic and syntactic variation, which requires an ontology-based mediation layer for automatic comparison or concurrence through manual means. If the IDFA determines that the LM is immature, then the IDFA proceeds with step 300. If the IDFA determines that the LM is mature, then the IDFA proceeds with step 400.

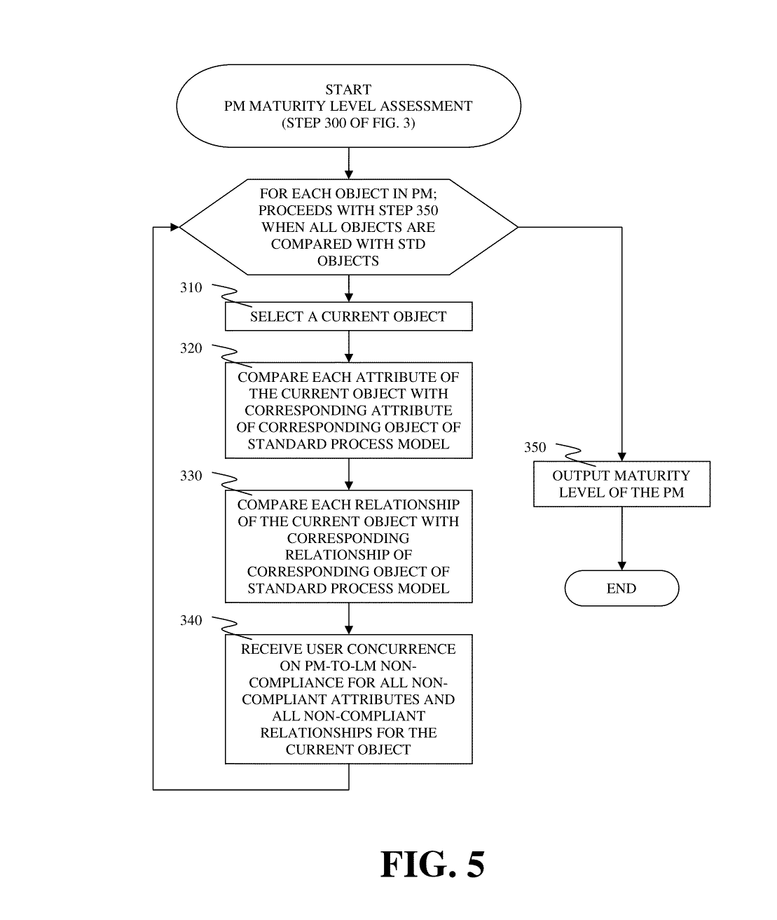

In step 300, the IDFA assesses maturity level of the PM because the LM is immature or nonexistent as determined in step 250 supra. See FIG. 5 infra and accompanying description for details of step 300. Then the IDFA proceeds with step 600.

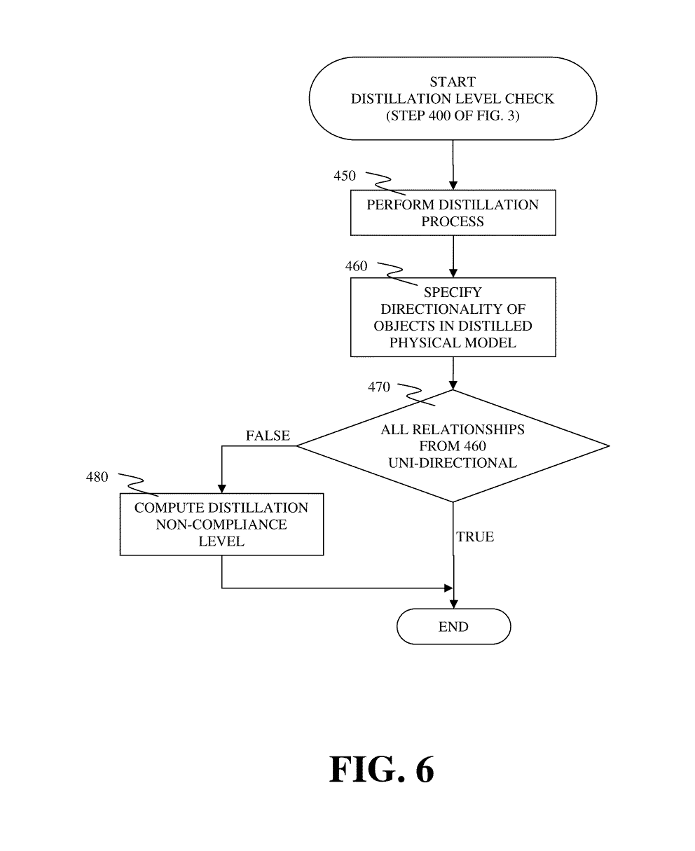

In step 400, the IDFA performs distillation process on the LM, which had been determined to be mature in step 200 supra, and checks a distillation level of resulting distilled physical model. In this specification, term “distillation” is defined as a transformation from the LM to a physical model of the cloud provider application such that the LM is implemented for the cloud by user of the physical model. In one embodiment of the present invention, the distillation process may be, inter alia, fixing directionalities of the objects in the physical model for all relationships other than parent-child relationship. See FIG. 6 infra and accompanying description for details of step 400. Then the IDFA proceeds with step 500.

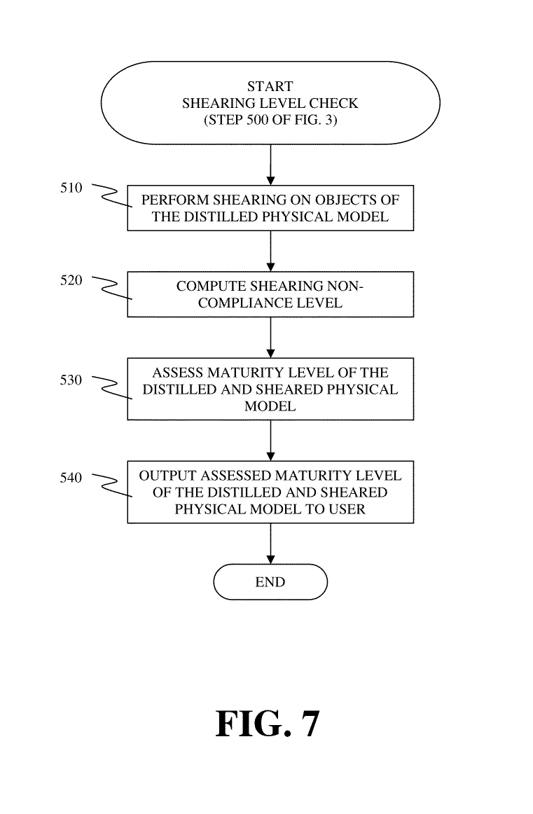

In step 500, the IDFA performs shearing process on the distilled physical model and checks shearing level of the distilled physical model, subsequent to step 400 supra. In one embodiment of the present invention, the shearing process may be, inter alia, merging distinctive objects in the LM into single object in the distilled physical model wherein the distinctive objects have a parent-child relationship, and merging attributes of the merged objects accordingly. In another embodiment, the IDFA performs the shearing process and the distillation process of step 500 supra concurrently while transforming the LM to the CP physical model. See FIG. 7 infra and accompanying description for details of step 500. Then the IDFA proceeds with step 600.

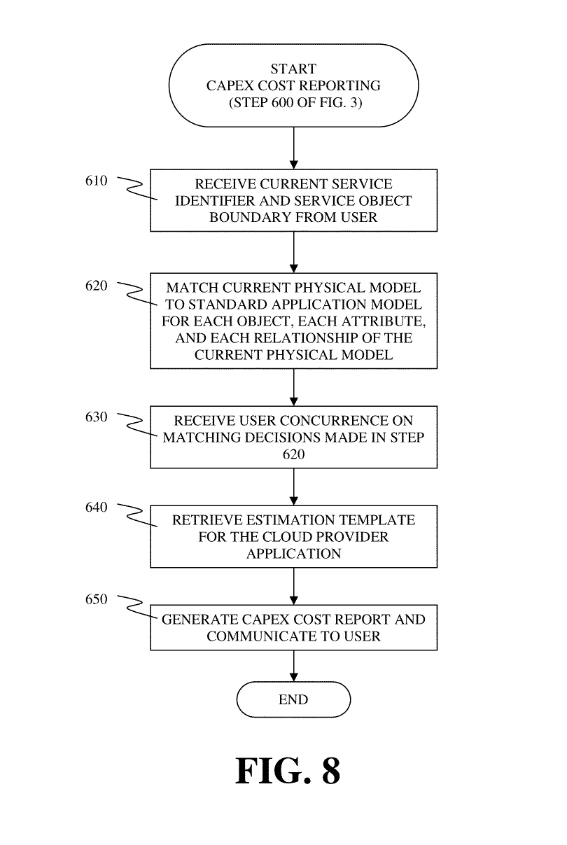

In step 600, the IDFA calculates and reports the Capital Expenditure (CAPEX) cost required to implement the cloud provider application pursuant to the standard application model. See FIG. 8 infra and accompanying description for details of step 600. Then the IDFA terminates assessing maturity level of the cloud provider application.

FIG. 4A is a flowchart depicting steps calculating compliance of a process model (PM) to a logical data model (LM) of the cloud provider application, performed as step 100 of the IDFA in FIG. 3 supra, in accordance with the embodiments of the present invention.

In step 110, the IDFA receives a standard process model, a standard Common Information Model (CIM), and a standard physical model of the standard application model. The standard process model dictates the process model (PM) of the cloud provider application. The standard CIM dictates the logical data model (LM) of the cloud provider application. The standard physical model dictates a physical model of the cloud provider application with respect to implementation. Data received by the IDFA in any step is stored in the storage and accessible by the IDFA. Then the IDFA proceeds with step 130.

In step 130, the IDFA receives the logical data model (LM) of the cloud provider application. Then the IDFA proceeds with step 140.

In step 140, the IDFA receives a request for the process model (PM) of the cloud provider application from a user. In one embodiment of the present invention, the user is a Business Analytics & Optimization (BAO) architect using the IDFA. Then the IDFA proceeds with step 140.

In step 150, the IDFA computes PM-to-LM compliance for the PM specified in the request received in step 140 supra by examining a linkage from the PM to the LM as Use Cases etc., and by representing the number of linkages over total number of examined items in percentage (%). Then the IDFA proceeds with step 200 of FIG. 3 supra.

FIG. 4B is a flowchart depicting steps calculating a maturity level of the LM of the cloud provider application against the standard CIM, performed as step 200 of the IDFA in FIG. 3 supra, in accordance with the embodiments of the present invention.

The IDFA performs steps 210 through 230 for each object in the LM. Upon running steps 210 through 230 for all objects in the LM, the IDFA proceeds with step 240. If the LM is null, having no objects/attributes/relationships, then the IDFA proceeds with step 240 directly.

In step 210, the IDFA selects a current object that had not been processed from the LM. Then the IDFA proceeds with step 220.

In step 220, the IDFA compares each attribute of the current object selected in step 210 supra with a respectively corresponding attribute of a respectively corresponding object of the standard CIM. Each compliant attribute is counted toward the maturity level of the LM. Then the IDFA proceeds with step 230.

In step 230, the IDFA compares each relationship of the current object selected in step 210 supra with a respectively corresponding relationship of a respectively corresponding object of the standard CIM. Each compliant relationship is counted toward the maturity level of the LM. Then the IDFA loops back to step 210 supra for a next object.

In step 240, the IDFA calculates the maturity level of the LM as a total count of all compliant attributes and compliant relationships as counted in steps 220 and 230 supra. If the LM is null, then the IDFA calculates the maturity level as zero (0), and the LM is deemed as immature in subsequent steps. Then the IDFA proceeds with step 250 of FIG. 3 supra.

FIG. 5 is a flowchart depicting steps for assessing a maturity level of the PM of the cloud provider application, performed as step 300 of the IDFA in FIG. 3 supra, in accordance with the embodiments of the present invention.

The IDFA performs steps 310 through 340 for each object in the PM. Upon running steps 310 through 340 for all objects in the PM, the IDFA proceeds with step 350.

In step 310, the IDFA selects a current object that had not been processed with steps 320 through 340 from the PM. Then the IDFA proceeds with step 320.

In step 320, the IDFA compares each attribute of the current object selected in step 310 supra with a respectively corresponding attribute of a respectively corresponding object of the standard process model. Each compliant attribute is counted toward the maturity level. Then the IDFA proceeds with step 330.

In step 330, the IDFA compares each relationship of the current object selected in step 310 supra with a respectively corresponding relationship of a respectively corresponding object of the standard process model. Each compliant relationship is counted toward the maturity level. Then the IDFA proceeds with step 340.

In step 340, the IDFA presents all non-compliant attributes and all non-compliant relationships for the current object, as determined in steps 320 and 330, supra, and receives a user concurrence on the non-compliance determination. Then the IDFA loops back to step 310 supra for a next object.

In step 350, the IDFA presents the maturity level of the PM in percentage (%), as cumulated during comparisons with the standard process model in steps 310 through 340. Then the IDFA proceeds with step 600 of FIG. 3 supra.

FIG. 6 is a flowchart depicting steps for a distillation process for a physical model of the cloud provider application, performed as step 400 of the IDFA in FIG. 3 supra, in accordance with the embodiments of the present invention.

The IDFA performs steps 410 through 430 for each object in the LM. Upon running steps 410 through 430 for all objects in the LM, the IDFA proceeds with step 450.

In step 410, the IDFA selects a current object that had not been processed from the LM. Then the IDFA proceeds with step 420.

In step 420, the IDFA compares each attribute of the current object selected in step 410 supra with a respectively corresponding attribute of a respectively corresponding object of the standard CIM. Each compliant attribute is counted toward the maturity level of the LM. Then the IDFA proceeds with step 430.

In step 430, the IDFA compares each relationship of the current object selected in step 410 supra with a respectively corresponding relationship of a respectively corresponding object of the standard CIM. Each compliant relationship is counted toward the maturity level of the LM. Then the IDFA loops back to step 410 supra for a next object.

In step 450, the IDFA performs a distillation process in which the LM is transformed into a physical model of the cloud provider application. In one embodiment of the present invention, the LM is in Unified Modeling Language (UML) format, and the physical model, also in UML format, distilled from the LM is more implementation oriented than the LM. In the same embodiment of the present invention, the IDFA fixes directionality of objects in the physical model for all relationships other than a parent-child relationship. In the same embodiment of the present invention, the IDFA gives names distinctive from original relationship names. Then the IDFA proceeds with step 460.

In step 460, the IDFA specifies directionality of objects in the distilled physical model resulting from step 450 supra based on relationships of the LM. For a bidirectional relationship in the LM, the IDFA specifies two distinctive relationships with a respective nailed direction for the distilled physical model. For an association relationship in the LM, the IDFA specifies a direction corresponding to the association relationship in the distilled physical model. Then the IDFA proceeds with step 470.

In step 470, the IDFA determines if all relationships in the distilled physical model are unidirectional. If the IDFA determines that all relationships in the distilled physical model are unidirectional, then the IDFA proceeds with step 500 of FIG. 3 supra. If the IDFA determines that at least one relationship in the distilled physical model is not unidirectional, then the IDFA proceeds with step 480.

In step 480, the IDFA computes a distillation non-compliance level in percentage (%) by comparing respectively corresponding elements between the distilled physical model and the standard physical model. Then the IDFA proceeds with step 500 of FIG. 3 supra.

FIG. 7 is a flowchart depicting steps for a shearing process for the physical model of the cloud provider application, performed as step 500 of the IDFA in FIG. 3 supra, in accordance with the embodiments of the present invention.

In step 510, the IDFA performs shearing on objects of the distilled physical model by merging two separate objects in the LM into single object in the distilled physical model if the two separate objects have a parent-child relationship with each other, and subsequently by merging attributes of the merged objects accordingly. Then the IDFA proceeds with step 520.

In step 520, the IDFA computes a shearing non-compliance level in percentage (%) of a number of objects that had been merged during step 510 supra over a total number of objects in the distilled and sheared physical model resulting from step 510. Then the IDFA proceeds with step 530.

In step 530, the IDFA make an assessment of the maturity level of the distilled and sheared physical model by performing steps 310 through 340 of FIG. 5 supra with the distilled and sheared physical model in place of the PM. Then the IDFA proceeds with step 540.

In step 540, the IDFA communicates the maturity level of the distilled and sheared physical model assessed from step 530 supra to the user. Then the IDFA proceeds with step 600 of FIG. 3 supra.

FIG. 8 is a flowchart depicting steps for reporting analysis results produced by the IDFA, performed as step 600 of the IDFA in FIG. 3 supra, in accordance with the embodiments of the present invention.

In step 610, the IDFA receives a current service identifier and a service object boundary associated with the current service identifier from the user. Then the IDFA proceeds with step 620.

In step 620, the IDFA matches each object, each attribute, and each relationship of a current physical model of the cloud provider application to a corresponding component of the physical model of the standard application model. The current physical model is either the distilled and sheared physical model from step 500 of FIG. 3 supra, or the physical model of the cloud provider application as received from the user in step 110 of FIG. 4 supra. If the logical data model of the cloud provider application had been determined as mature in step 250 of FIG. 3 supra, then the current physical model is the distilled and sheared physical model in steps 400 and 500 of FIG. 3 supra. If the logical data model of the cloud provider application had been determined as not mature in step 250 of FIG. 3 supra, then the current physical model is the physical model of the standard application model, as received in step 110 of FIG. 4 supra. Then the IDFA proceeds with step 630.

In step 630, the IDFA receives user concurrence on matching decisions made in step 620 supra by prompting the user for input while displaying results of the matching elements. Then the IDFA proceeds with step 640.

In step 640, the IDFA retrieves an estimate template for the cloud provider application from the storage of the IDFA, as predefined by the user for cost estimation. Then the IDFA proceeds with step 650.

In step 650, the IDFA generates a Capital Expenditure (CAPEX) cost report by applying elements from the current physical model to the estimate template, and subsequently communicates the generated CAPEX cost report to the user. Then the IDFA terminates analysis of the cloud provider application model.

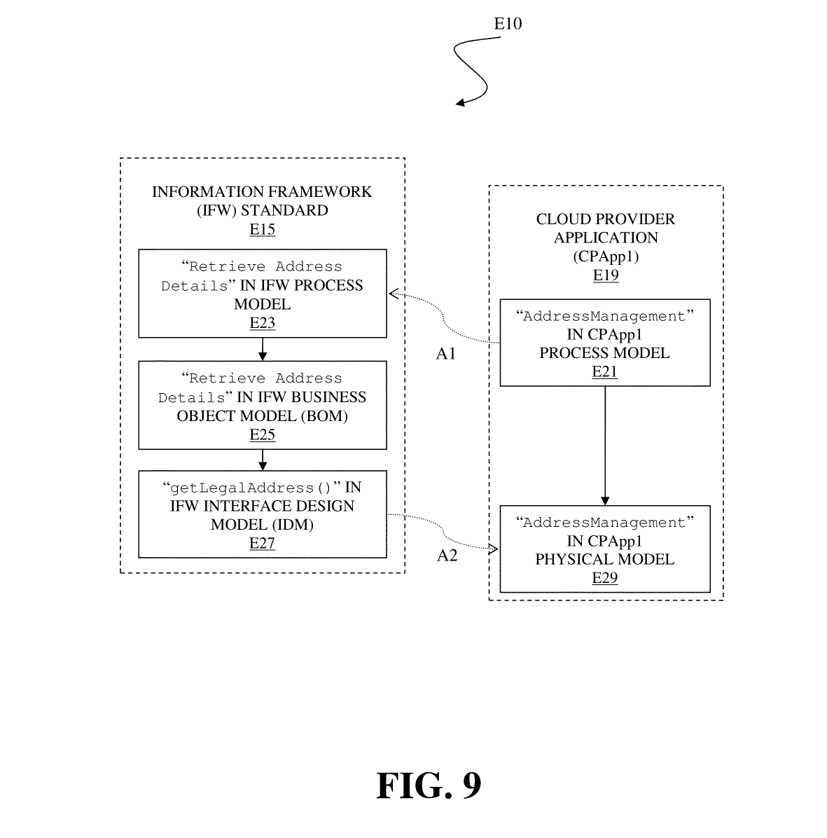

FIG. 9 is an exemplary analysis result E10 of Information Framework (IFW) standard E15 and a cloud provider application CPApp1 E19, as created by the IDFA in the storage in the system 10 of FIG. 1 supra resulting from automatically assessing maturity for the CPApp1 E19 against the IFW standard E15, in accordance with embodiments of the present invention.

The exemplary analysis result E10 is produced in a cloud environment wherein the cloud provider utilizes an IBM® Information FrameWork (IFW) standard model for implementation of the cloud provider application CPApp1 E19. (IBM is a registered trademark of International Business Machines Corporation in the United States and other countries).

The cloud provider application CPApp1 E19 is an instance of the cloud provider application model of FIG. 1 supra, comprising a CPApp1 process model and a CPApp2 physical model.

The IFW standard E15 is an instance of the standard application model of FIG. 1 supra, comprising an IFW process model, an IFW Business Object Model (BOM), and an IFW Interface Design Model (IDM). The IFW BOM is a logical data model of the IFW standard E15, and the IFW IDM is a physical model of the IFW standard E15.

The IDFA starts analysis from a service specification of a service AddressManagement. The CPApp1 comprises a process AddressManagement E21 in the CPApp1 process model and a procedure AddressManagement E29 in the CPApp1 physical model, in WSDL and/or XSD format, etc. Because the CPApp1 does not have a logical data model, the IDFA proceeds with step 300 after performing step 100, steps 100 and 300 of FIG. 3 supra.

The IDFA maps the CPApp1 process AddressManagement E21 to a process Retrieve Address Details E23 in IFW process model, as shown in arrow A1. Within the IFW standard E15, the service Retrieve Address Details E23 is transformed to an object Retrieve Address Details E25 in the IFW BOM corresponding to the process Retrieve Address Details E23, and then the object Retrieve Address Details E25 is transformed to an interface call getLegalAddress ( ) E27 in the IFW IDM. The IDFA compares the interface call getLegalAddress ( ) E27 with the procedure AddressManagement E29 for maturity level assessment, as shown in arrow A2.

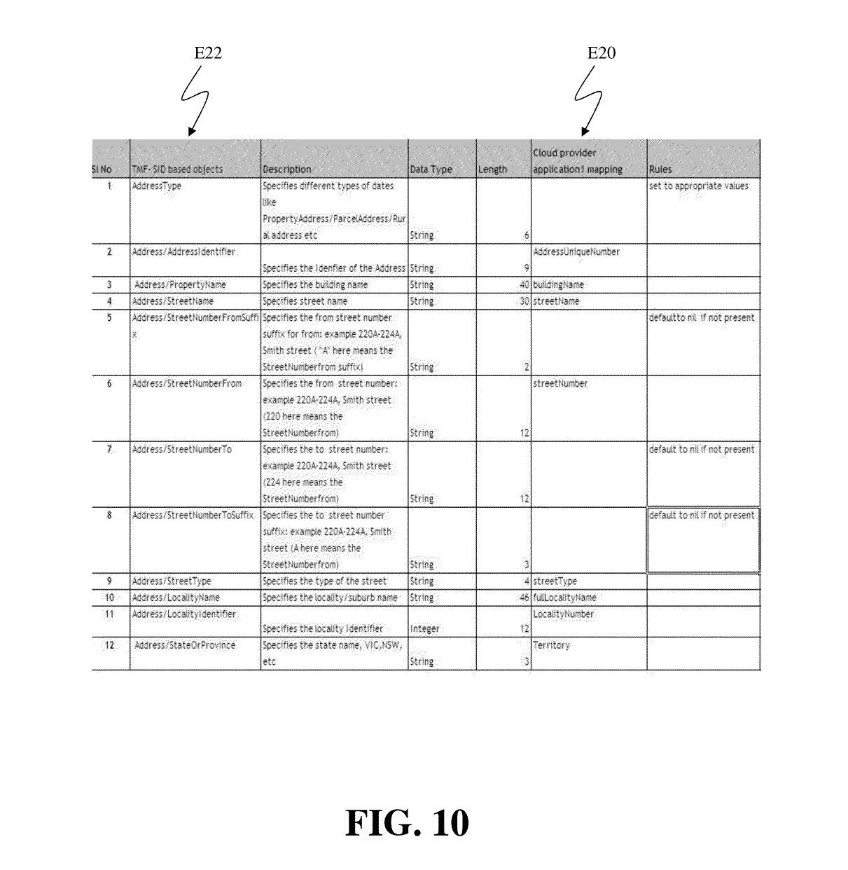

FIG. 10 is an example of a service object boundary input in step 370 of FIG. 5 supra, in accordance with embodiments of the present invention.

Continuing from the example in FIG. 9 supra, a service boundary of a service AddressManagement is shown using an industry standard in telecommunications, Shared Information Data Model by TeleManagement Forum (TMF SID).

Column Cloud Provider application 1 mapping E20 specifies a respective mapping of the AddressManagement service in the CPApp1 for each standard object in the standard TMF SID. In each row, a non-null string in the E20 column shows that the CPApp1 has a mapping named with the non-null string for the object of the row distinctive from a corresponding TMF SID object, which is regarded as a non-compliant mapping which detriments a maturity level of the CPApp1. Mappings non-compliant to the standard will cost time and effort for mediation, which is represented as Capital Expenditure (CAPEX) cost.

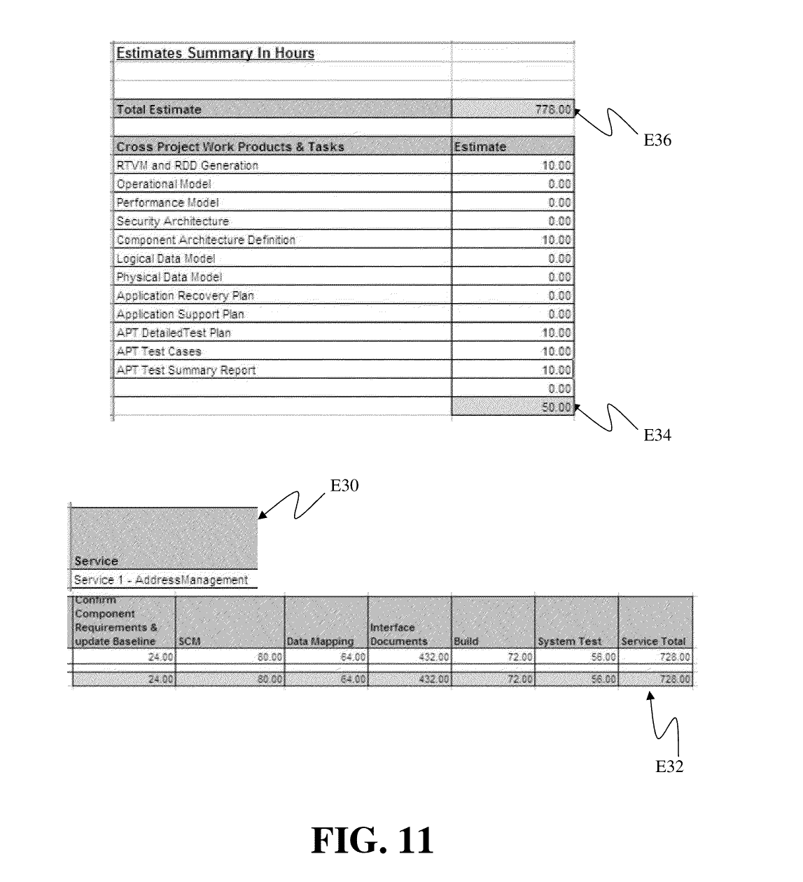

FIG. 11 is an example estimation template as input in step 640 of FIG. 8 supra, in accordance with embodiments of the present invention.

The estimation template comprises a service estimation template E30 and an integration estimation template. A total estimate E36 is a sum of a service total E32 from the service estimation template E30 and an integration total E34 from the integration estimation template. The service total E32 comprises costs for developing a mediation component for adapting CPApp1 to TMF SID.

In the integration estimation template, “RTVM” of a first row indicates Requirements Traceability Verification Matrix, “RDD” of the first row indicates Resource Description Framework. In the service estimation template E30, “SCM” indicates a task of Software Configuration Management.

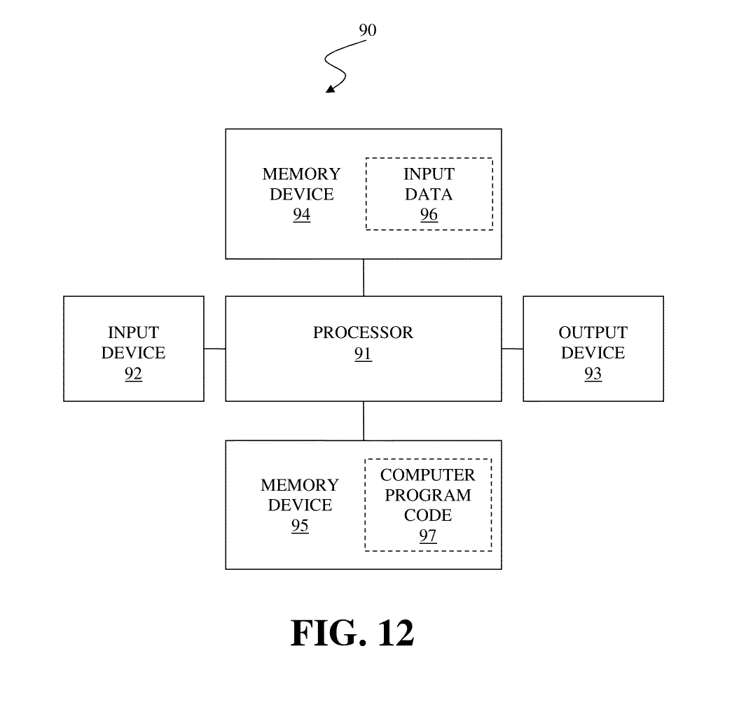

FIG. 12 illustrates a computer system 90 used for automatic maturity assessment for a cloud provider application, in accordance with the embodiments of the present invention.

The computer system 90 comprises a processor 91, an input device 92 coupled to the processor 91, an output device 93 coupled to the processor 91, and memory devices 94 and 95 each coupled to the processor 91. In this specification, the computer system 90 represents any type of programmable data processing apparatus.

The input device 92 is utilized to receive input data 96 into the computer system 90. The input device 92 may be, inter alia, a keyboard, a mouse, a keypad, a touch screen, a scanner, a voice recognition device, a sensor, a network interface card (NIC), a Voice/video over Internet Protocol (VOIP) adapter, a wireless adapter, a telephone adapter, a dedicated circuit adapter, etc. The output device 93 is utilized to communicate results generated by the computer program code 97 to a user of the computer system 90. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc.

Any of the components of the present invention can be deployed, managed, serviced, etc. by a service provider that offers to deploy or integrate computing infrastructure with respect to a process for automatic maturity assessment for a cloud provider application of the present invention. Thus, the present invention discloses a process for supporting computer infrastructure, comprising integrating, hosting, maintaining and deploying computer-readable code into a computing system (e.g., computing system 90), wherein the code in combination with the computing system is capable of performing a method for automatic maturity assessment for a cloud provider application.

In another embodiment, the invention provides a method that performs the process steps of the invention on a subscription, advertising and/or fee basis. That is, a service provider, such as a Solution Integrator, can offer to create, maintain, support, etc., a process for automatic maturity assessment for a cloud provider application of the present invention. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 12 shows the computer system 90 as a particular configuration of hardware and software, any configuration of hardware and software, as would be known to a person of ordinary skill in the art, may be utilized for the purposes stated supra in conjunction with the particular computer system 90 of FIG. 12. For example, the memory devices 94 and 95 may be portions of a single memory device rather than separate memory devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. In this specification, the term “memory device” 94, 95 represent a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code 97 for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer program code 97 may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. The term “computer program instructions” is interchangeable with the term “computer program code” 97 in this specification. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically assessing standard-orientation maturity for a custom application providing a service in a standard-governed computing environment, said method comprising:
calculating a first compliance level representing how compliant a logical data model of the custom application is to a process model of the custom application, wherein the logical data model specifies data objects of the custom application necessary to provide the service specified by the process model;
calculating a first maturity level representing how well the logical data model is aligned with a standard logical data model of a standard application model, by comparing each element of the logical data model with a respectively corresponding element of the standard logical data model, wherein the standard logical data model specifies standardized data objects necessary to provide the service described in a standard process model of the standard application model in the standard-governed computing environment, and wherein the standard process model corresponds to the process model for the custom application;
calculating a capital expenditure cost for mediating the service provided by the custom application into the standard application model based on a physical model of the custom application, a standard physical model of the standard application model, and a cost estimation template; and
communicating the calculated capital expenditure cost to a user such that the user determines if the custom application is suitable for the standard-governed computing environment.

2. The method of claim 1, further comprising:
subsequent to said calculating the first maturity level and prior to calculating the capital expenditure cost, performing steps of:
determining that the logical data model is mature by comparing the calculated first maturity level and a maturity threshold;
generating the physical model of the custom application by deriving from the mature logical data model from said determining and by specifying directionality of relationships of objects in the generated physical model such that the objects of the generated physical model is configured to count a first number of objects that have unidirectional relationships; and
counting a second number of sheared objects in the generated physical model, wherein two objects having a parent-child relationship in the generated physical model is merged into a sheared object in the sheared physical model.

3. The method of claim 2, said generating further comprising:
ascertaining that the generated physical model has at least one non-unidirectional relationship; and
computing a second compliance level representing how compliant the generated physical model from said ascertaining is to the logical data model of the custom application.

4. The method of claim 2, said counting further comprising:
computing a third compliance level representing how compliant the sheared physical model is to the logical data model of the custom application; and
assessing a second maturity level representing how compliant the sheared physical model from said computing is to the standard physical model of the standard application model.

5. The method of claim 1, further comprising:
subsequent to said calculating the first maturity level and prior to calculating the capital expenditure cost, performing steps of:
determining that the logical data model is immature by comparing the calculated first maturity level and a maturity threshold; and
assessing a third maturity level representing how compliant the process model of the custom application is to the standard process model of the standard application model such that the user determines if the custom application can be implemented by use of the standard physical model.

6. A computer program product comprising:
a computer readable memory unit that embodies a computer readable program code, said computer readable program code containing instructions that perform a method for automatically assessing standard-orientation maturity for a custom application providing a service in a standard-governed computing environment, said method comprising:
calculating a first compliance level representing how compliant a logical data model of the custom application is to a process model of the custom application, wherein the logical data model specifies data objects of the custom application necessary to provide the service specified by the process model;
calculating a first maturity level representing how well the logical data model is aligned with a standard logical data model of a standard application model, by comparing each element of the logical data model with a respectively corresponding element of the standard logical data model, wherein the standard logical data model specifies standardized data objects necessary to provide the service described in a standard process model of the standard application model in the standard-governed computing environment, and wherein the standard process model corresponds to the process model for the custom application;
calculating a capital expenditure cost for mediating the service provided by the custom application into the standard application model based on a physical model of the custom application, a standard physical model of the standard application model, and a cost estimation template; and
communicating the calculated capital expenditure cost to a user such that the user determines if the custom application is suitable for the standard-governed computing environment.

7. The computer program product of claim 6, further comprising:
subsequent to said calculating the first maturity level and prior to calculating the capital expenditure cost, performing steps of:
determining that the logical data model is mature by comparing the calculated first maturity level and a maturity threshold;
generating the physical model of the custom application by deriving from the mature logical data model from said determining and by specifying directionality of relationships of objects in the generated physical model such that the objects of the generated physical model is configured to count a first number of objects that have unidirectional relationships; and
counting a second number of sheared objects in the generated physical model, wherein two objects having a parent-child relationship in the generated physical model is merged into a sheared object in the sheared physical model.

8. The computer program product of claim 7, said generating further comprising:
ascertaining that the generated physical model has at least one non-unidirectional relationship; and
computing a second compliance level representing how compliant the generated physical model from said ascertaining is to the logical data model of the custom application.

9. The computer program product of claim 7, said counting further comprising:
computing a third compliance level representing how compliant the sheared physical model is to the logical data model of the custom application; and
assessing a second maturity level representing how compliant the sheared physical model from said computing is to the standard physical model of the standard application model.

10. The computer program product of claim 6, further comprising:
subsequent to said calculating the first maturity level and prior to calculating the capital expenditure cost, performing steps of:
determining that the logical data model is immature by comparing the calculated first maturity level and a maturity threshold; and
assessing a third maturity level representing how compliant the process model of the custom application is to the standard process model of the standard application model such that the user determines if the custom application can be implemented by use of the standard physical model.

11. A computer system comprising a processor, a memory coupled to the processor, and a computer readable storage device coupled to the processor, said storage device containing program code configured to be executed by the processor via the memory to implement a method for automatically assessing standard-orientation maturity for a custom application providing a service in a standard-governed computing environment, said method comprising:
calculating a first compliance level representing how compliant a logical data model of the custom application is to a process model of the custom application, wherein the logical data model specifies data objects of the custom application necessary to provide the service specified by the process model;
calculating a first maturity level representing how well the logical data model is aligned with a standard logical data model of a standard application model, by comparing each element of the logical data model with a respectively corresponding element of the standard logical data model, wherein the standard logical data model specifies standardized data objects necessary to provide the service described in a standard process model of the standard application model in the standard-governed computing environment, and wherein the standard process model corresponds to the process model for the custom application;
calculating a capital expenditure cost for mediating the service provided by the custom application into the standard application model based on a physical model of the custom application, a standard physical model of the standard application model, and a cost estimation template; and
communicating the calculated capital expenditure cost to a user such that the user determines if the custom application is suitable for the standard-governed computing environment.

12. The computer system of claim 11, further comprising:
subsequent to said calculating the first maturity level and prior to calculating the capital expenditure cost, performing steps of:
determining that the logical data model is mature by comparing the calculated first maturity level and a maturity threshold;
generating the physical model of the custom application by deriving from the mature logical data model from said determining and by specifying directionality of relationships of objects in the generated physical model such that the objects of the generated physical model is configured to count a first number of objects that have unidirectional relationships; and
counting a second number of sheared objects in the generated physical model, wherein two objects having a parent-child relationship in the generated physical model is merged into a sheared object in the sheared physical model.

13. The computer system of claim 12, said generating further comprising:
ascertaining that the generated physical model has at least one non-unidirectional relationship; and
computing a second compliance level representing how compliant the generated physical model from said ascertaining is to the logical data model of the custom application.

14. The computer system of claim 12, said counting further comprising:
computing a third compliance level representing how compliant the sheared physical model is to the logical data model of the custom application; and
assessing a second maturity level representing how compliant the sheared physical model from said computing is to the standard physical model of the standard application model.

15. The computer system of claim 11, further comprising:
subsequent to said calculating the first maturity level and prior to calculating the capital expenditure cost, performing steps of:
determining that the logical data model is immature by comparing the calculated first maturity level and a maturity threshold; and
assessing a third maturity level representing how compliant the process model of the custom application is to the standard process model of the standard application model such that the user determines if the custom application can be implemented by use of the standard physical model.

16. A process for supporting computer infrastructure, said process comprising providing at least one support service for at least one of creating, integrating, hosting, maintaining, and deploying computer-readable code in a computing system, wherein the code in combination with the computing system is capable of performing a method for automatically assessing standard-orientation maturity for a custom application providing a service in a standard-governed computing environment, said method comprising:
calculating a first compliance level representing how compliant a logical data model of the custom application is to a process model of the custom application, wherein the logical data model specifies data objects of the custom application necessary to provide the service specified by the process model;
calculating a first maturity level representing how well the logical data model is aligned with a standard logical data model of a standard application model, by comparing each element of the logical data model with a respectively corresponding element of the standard logical data model, wherein the standard logical data model specifies standardized data objects necessary to provide the service described in a standard process model of the standard application model in the standard-governed computing environment, and wherein the standard process model corresponds to the process model for the custom application;
calculating a capital expenditure cost for mediating the service provided by the custom application into the standard application model based on a physical model of the custom application, a standard physical model of the standard application model, and a cost estimation template; and
communicating the calculated capital expenditure cost to a user such that the user determines if the custom application is suitable for the standard-governed computing environment.

17. The process of claim 16, further comprising:
subsequent to said calculating the first maturity level and prior to calculating the capital expenditure cost, performing steps of:
determining that the logical data model is mature by comparing the calculated first maturity level and a maturity threshold;
generating the physical model of the custom application by deriving from the mature logical data model from said determining and by specifying directionality of relationships of objects in the generated physical model such that the objects of the generated physical model is configured to count a first number of objects that have unidirectional relationships; and
counting a second number of sheared objects in the generated physical model, wherein two objects having a parent-child relationship in the generated physical model is merged into a sheared object in the sheared physical model.

18. The process of claim 17, said generating further comprising:
ascertaining that the generated physical model has at least one non-unidirectional relationship; and
computing a second compliance level representing how compliant the generated physical model from said ascertaining is to the logical data model of the custom application.

19. The process of claim 17, said shearing further comprising:
computing a third compliance level representing how compliant the sheared physical model is to the logical data model of the custom application; and
assessing a second maturity level representing how compliant the sheared physical model from said computing is to the standard physical model of the standard application model.

20. The process of claim 16, further comprising:
subsequent to said calculating the first maturity level and prior to calculating the capital expenditure cost, performing steps of:
determining that the logical data model is immature by comparing the calculated first maturity level and a maturity threshold; and
assessing a third maturity level representing how compliant the process model of the custom application is to the standard process model of the standard application model such that the user determines if the custom application can be implemented by use of the standard physical model.
